(19) United States
(12) Patent Application Publication
(10) Pub. No.: US 2021/0317349 A1
(43) Pub. Date: Oct. 14, 2021

(54) CARTRIDGE COVERING ELEMENT FOR SEALING OFF A MICROFLUIDIC CARTRIDGE

(71) Applicant: LOHMANN GMBH & CO. KG, Neuwied (DE)

(72) Inventors: Oliver KÜHL, Straßenhaus (DE); Kerstin SCHINDLER, Rederscheid (DE); Cornelia SUNDRUM, Koblenz (DE); Raimund ROTHER, Freiburg (DE); Rouven STRELLER, Hinterzarten (DE)

(73) Assignee: LOHMANN GMBH & CO. KG, Neuwied (DE)

(21) Appl. No.: 17/264,454

(22) PCT Filed: Jul. 31, 2019
(86) PCT No.: PCT/EP2019/070622

§ 371 Date: Jan. 29, 2021

(30) Foreign Application Priority Data
Jul. 31, 2018 (DE) 10 2018 118 581.2

(51) Int. Cl. C09J 163/00; C09J 5/00; B01L 3/00; C09J 11/04; C09J 7/38

(52) U.S. Cl. CPC C09J 163/00; C09J 5/00; B01L 3/502707; B01L 3/565; C09J 11/04; C09J 7/38; C08K 7/20; B01L 2200/0689; B01L 2300/168; B01L 2300/123; C09J 2463/00; C09J 2301/416; C09J 2301/408; B01L 2200/12

(57) ABSTRACT

A cartridge covering element for sealing off a microfluidic cartridge comprising: at least one stratified adhesive mass, the stratified adhesive mass being UV-activatable to induce curing and being tacky at room temperature prior to and after activation until expiry of an open time.

### CROSS REFERENCE TO RELATED APPLICATIONS

This application is a national stage U.S. patent application of International Application No. PCT/EP2019/070622, filed on Jul. 31, 2019, and claims foreign priority to German Patent Application No. DE 10 2018 118 581.2, filed on Jul. 31, 2018, the entirety of each of which is incorporated herein by reference.

### TECHNICAL FIELD

The present disclosure relates to a cartridge covering element for microfluidic cartridges, a method for producing a cartridge covering element and a method for sealing off a microfluidic cartridge.

### DESCRIPTION OF THE RELATED ART

For in-vitro diagnostics or diagnostic therapy monitoring of various diseases, microfluidic systems are used as polymer test carriers. The test carriers typically include a microfluidic system by way of which a biological assay can be processed in an automated fashion.

The production of a test carrier requires the provision of a cartridge that is, for example, produced using a micro-thermoforming or an injection moulding technique. The cartridge is then equipped with the reagents (solid and liquid) required for the desired function. Subsequently, the cartridge is sealed off with a sealing film.

The customary techniques for sealing off a cartridge include cold sealing, thermal diffusion sealing, laser welding and solvent sealing.

In cold sealing (adhesives), an acrylate-based film is placed on the cartridge, with the exertion of pressure destroying micro-capsules, thus creating adhesion only in the desired locations. Whilst adhesive bonding is easily achieved, it may also cause blockage of the microfluidic ducts of the cartridge, and it is associated with relatively poor seal seam capacity and strength, especially at higher temperatures.

Thermal diffusion sealing is characterised by high seal seam strength. However, in the case of thermo-sensitive reagents, the method is susceptible to negative influences due to the sealing temperature. Moreover, seal films are not readily commercially available.

Laser welding is easy to implement in terms of process technology, however, for transparent/transparent materials, it has not yet reached an adequately sophisticated technical level and is associated with high purchasing costs.

Solvent sealing allows for high seal seam strengths. Due to the solvents used (mostly toxic solvents), solvent sealing is difficult to handle, requires a safe workspace (vent) and may negatively affect the biochemical reagents.

WO 2017/117163 A1 relates to a dual stage structural bonding adhesive.

US 2015/0184034 A1 relates to an adhesive layer and adhesive sheet.

### BRIEF DESCRIPTION OF THE FIGURES

Preferred embodiments are illustrated in further detail by the subsequent description of the Figures.

FIG. 1 schematically shows a cartridge covering element 10, comprising a first cover layer;

FIG. 2 schematically shows the cartridge covering element 10 of FIG. 1, comprising an additional second cover layer 51;

FIG. 3 schematically shows a cartridge covering element 10, comprising a removable film;

FIG. 4 schematically shows a cartridge covering element 10, comprising a removable film on both sides;

FIG. 5 schematically shows a cartridge covering element 10, sealing off a microfluidic cartridge; and

FIG. 6 schematically shows a stratified adhesive mass 30 comprising fillers 40.

### DISCLOSURE OF THE EMBODIMENTS

The terminology used in the descriptions below is to be understood as follows:

“Adhesive film” hereinafter relates to any type of a really adhesive systems, i.e. including adhesive tapes, and also adhesive films, adhesive strips, adhesive plates or adhesive stamped parts.

“Pressure-sensitive adhesive” refers to adhesive bonds where the two join partners are bonded together by way of an intermediary adhesive layer and subject to pressure. The bond is reversible in that it can be released again without damaging the two join partners, because the adhesive seam is the weakest link in the adhesive bond.

“Structural” adhesive bonds are such bonds where the join partners are bonded in such a manner that, in the event of separation, the bond is not necessarily released at the adhesive seam but that, under certain circumstances, also one of the join partners may constitute the weakest link in the bond, which is then damaged due to the separation. This means that structural adhesive bonds possess high strength. The strength, measured by way of a quasi-static tensile shear test, exceeds 6 MPa for structural bonds. Typical values, aspired for structural adhesive bonds of epoxy adhesives, lie at 30 MPa.

In the case in hand, UV radiation is understood to be radiation in the UV-A or UV-C wavelength range, in particular “UV-A” or “UV-C” light. UV-A radiation is in a wavelength range of ca. 380 to 315 nanometres (nm), UV-C radiation is in a wavelength range of ca. 280 to 100 nm. Generally, both constitute electromagnetic radiation at wavelengths shorter than visible light. For UV-A light, the energy input is approx. 3.26 to 3.95 electron volts (eV), for UV-C light, the energy input is approx. 4.43 to 12.40 eV.

“Activation” means that the adhesive starts curing after irradiation with UV light, i.e. the photo initiators included in the adhesive are activated by light irradiation and trigger the curing process by initiating the formation of polymer chains. Customarily, UV-curing adhesives are irradiated after the join partners have been put together. For this, substrates that are sufficiently permeable are employed for the used UV radiation. The adhesion seam is irradiated until the curing has progressed sufficiently.

The “open time” is the time between the application of the adhesive and the bonding. In the case of UV-activatable adhesives, the open time is understood to be the time between UV-activation and adhesive bonding, i.e. the time after activation during which an adhesive bond can be created. During the open time, for example, a cartridge covering element is applied on a cartridge to be sealed off. The adhesive mass included in the cartridge covering element provides for the desired adhesion. As the viscosity of an adhesive mass generally increases after application, the open time of adhesive masses is limited due to time constraints.

The “curing time” is the period between the joining of the join partners and reaching the final strength of the bond.

The term “dark reaction” shall refer to the fact that a curing reaction is triggered by short-term irradiation of the adhesive mass with UV light, which can effect a complete curing without additional irradiation.

The term “cover layer” shall refer to a layer arranged on an adhesive mass that permanently covers the cartridge. The cover layer may permanently remain on the cartridge covering element for protection purposes. Alternatively, the cover layer may be provided as a removable film that is removed prior to application, i.e. prior to being joined to a cartridge.

It is an object of the present disclosure to provide an improved device for sealing off a microfluidic cartridge and a corresponding method.

This object is realised by a cartridge covering element for closing and sealing off a microfluidic cartridge with the features of claim 1, a method for producing a cartridge covering element with the features of claim 11 and a method for closing a microfluidic cartridge with the features of claim 12. Advantageous further embodiments derive from the dependent claims.

A first aspect of the disclosure relates to a cartridge covering element for sealing off a microfluidic cartridge comprising at least one stratified adhesive mass. According to the invention, the stratified adhesive mass is UV-activatable to induce curing and being tacky at room temperature after activation until expiration of an open time. Alternatively, the stratified adhesive mass may also be tacky prior to UV-activation.

Due to the fact that the stratified adhesive mass is tacky in its non-activated state prior to the expiration of the open time, the cartridge covering element can thus be handled just like any “regular” pressure-sensitive adhesive tape, i.e. it can be applied whilst offering mild tack and it can also be removed again or even repositioned before expiration of the open time. After expiration of the open time, the join partners are finally and structurally bonded.

According to an embodiment, the cartridge covering element for sealing off a microfluidic cartridge comprises at least one stratified adhesive mass, comprising:
2-40 percent by weight of film former,
10-70 percent by weight of aromatic epoxy resins,
cyclo-aliphatic epoxy resins, the cyclo-aliphatic epoxy resins not exceeding 35 percent by weight,
0.5-7 percent by weight of cationic initiators,
0-50 percent by weight of epoxy-enhanced polyether compounds, and
0-20 percent by weight of polyol,
   the shares adding up to 100%. Surprisingly, it was found that due to the composition of the stratified adhesive mass, the curing of which is triggered by UV-activation, this stratified adhesive mass is tacky during the open time, and after expiration of the open time finally results in structural compound strength.

An advantageous component of the stratified adhesive mass is a film former. Film formers can be thermoplastic or elastomer polymer compounds that regulate viscosity. For example, the following polymers can be used as film formers: Acrylates, polyamides, phenoxy resins, polyurethanes or ethylene vinyl acetates (EVAs), whereas preferably polyurethanes and ethylene vinyl acetate copolymers are used.

Aromatic, aliphatic and cyclo-aliphatic epoxy resins may be used as epoxy resins. In terms of viscosity, they can be liquid, highly viscous or solid. Preferably, measured by the share of the epoxy equivalent of the mixture, the share of aromatic resins is higher than the share of cyclo-aliphatic epoxy resins. In a further embodiment, the share of the epoxy equivalent of the cyclo-aliphatic epoxy resins in the epoxy equivalent of all epoxy resins is in a range between 0% and 35%.

In a further embodiment, the share of the epoxy equivalent of the aromatic epoxy resins in the epoxy equivalent of all epoxy resins is above 60%.

With such formulations, open times of up to 60 minutes are generally feasible.

Advantageously, the stratified adhesive mass includes at least one polyether compound that has been derivatised with epoxy groups. Particularly preferably, these are epoxy-enhanced polyethylene glycols or poly-propylene glycols. In a further embodiment, the share of the epoxy equivalent of the epoxy-enhanced polyether compounds in the epoxy equivalent of all epoxy resins is between 0% and 40%. Based on the share of the polyether compounds, it is possible to effectively adjust the open time.

Compounds with a plurality of free hydroxy-groups (polyols) such as for example poly-ethylene glycols, poly-tetrahydrofurane or poly-propylene glycols may constitute another component of the stratified adhesive mass. According to the literature, adding polyols is responsible for delaying the curing reaction (A. Hartwig, “Kationisch härtende Epoxidharzklebstoffe” [cationically curing epoxy resin adhesives], February 2012). According to that document, transmission reactions cause an extension of the curing reaction, resulting in a dark reaction. Together with the epoxy-enhanced polyethers, polyols are consequently useful for controlling the open time and the speed of the cross-linking reaction.

As initiators for the stratified adhesive mass cationic photo-initiators can be used. Suitable initiators are, for example: aryl sulfonium, iodonium, ferrocenium or thioxathenium salts, especially preferably triarylsulfonium salts. They are characterised by a fast decay reaction already at relatively low UV irradiation. When the initiators decay, acids are formed that cure epoxy resins.

As further components for the stratified adhesive mass, the following additives for epoxy adhesive tapes known to the skilled person are available: Shock resistance modifiers, organic or inorganic fillers, also functional fillers such as flame protection substances, dyes, anti-ageing agents, levelling and rheology adjuvants.

In a further embodiment, the stratified adhesive mass has an open time of 0 seconds to 60 minutes after UV-activation, preferably 0 seconds to 30 minutes and particularly preferably 10 seconds to 60 minutes during which the film is tacky.

Preferably, the stratified adhesive mass cures after UV-activation without the application of heat or UV light.

In yet another embodiment, the stratified mass forms a thermoset film during curing.

In yet a further embodiment, the stratified adhesive mass only adheres to the surfaces of the microfluidic cartridge after curing, including, for example in substrates such as COP, PC or ABS. Advantageously, the stratified adhesive mass is no longer tacky at the locations of the ducts.

In a further embodiment, a very thin adhesive layer thickness is sufficient to obtain very high sealing strength due to a reactive epoxy resin system. This can have the advantage that the ducts of the cartridge are not blocked by the adhesive mass: The smaller the adhesive thickness, the smaller the risk of the ducts being blocked by the adhesive mass.

In yet a further embodiment, the stratified adhesive mass has a thickness of 2 to 1,000 μm, alternatively a thickness of 5 to 500 μm, a thickness of 5 to 200 μm or a thickness of 5 to 100 μm. It is advantageous to select the thickness so as to provide for sufficient adhesive force and at the same time to prevent blockage of the ducts by the stratified adhesive mass. Smaller thicknesses of the stratified adhesive mass are, inter alia, associated with the advantage that less of the adhesive mass needs to be used.

In yet another embodiment, the stratified adhesive mass comprises fillers. The fillers may, inter alia, be ceramic fillers or, in the alternative, polymer-based fillers. For example, the fillers may be solid glass spheres, hollow glass spheres and/or polymer spheres. Advantageously, the maximum dimensions of a filler, alternatively the diameter of a filler or alternatively the smallest diameter of a filler, is smaller than the thickness of the stratified adhesive mass. The fillers may inter alia have a positive impact on the elastic properties of the stratified adhesive mass or the elastic properties of the cartridge covering element, which in turn may result in an advantageous sealing of the microfluidic cartridge. The addition of fillers may also have the effect that the stratified adhesive mass or, alternatively, the entire cartridge covering element can be produced in a relatively more economical fashion.

In yet another embodiment, on a first side of the stratified adhesive mass a cover layer, preferably a plastic film operating as a cover film, is arranged. The cover layer may, for example, also assume the function of a carrier material. Additionally, the cover layer may increase stability of the cartridge covering element, in particular if the cover layer remains in the device during the use of the microfluidic cartridge. Also, the cover layer may protect the stratified adhesive mass, for example against external influences, such as chemical, physical or mechanical influences. The cover layer may be advantageous inasmuch it allows for rolling up the cartridge covering element without the stratified adhesive mass disadvantageously sticking to itself in the process. Moreover, the cover layer may also allow for stacking multiple separate cartridge covering elements without the stratified adhesive masses disadvantageously sticking to each other.

In a further embodiment, the cover layer is removable. For example, the cover layer may be a removable film or a release liner. Thus, the cover layer can be removed again after joining the cartridge covering element and the microfluidic cartridge or after the stratified adhesive mass has cured. This is advantageous, for example, if the optical properties of the cartridge covering element have to satisfy demanding quality requirements.

The curing of the stratified adhesive mass is triggered by UV-activation. A thermoset film is formed during curing. Preferably, the cured stratified adhesive mass exhibits the desired stability and/or the desired resilience against external influences, in particular chemical, physical or mechanical influences.

In an advantageous further embodiment, the stratified adhesive mass has a thickness of >5 μm, >100 μm, >500 μm or >1000 μm.

In another embodiment, a cover layer is arranged on a second side of the stratified adhesive mass, which preferably may operate as a removable film. This cover layer may serve as carrier material, too. Additionally, the cover layer protects the stratified adhesive mass, for example against external influences, such as chemical, physical and/or mechanical influences. Also, this cover layer may be advantageous inasmuch it allows for rolling up the cartridge covering element without the stratified adhesive mass disadvantageously sticking to itself, or because it allows for stacking multiple separate cartridge covering elements without the stratified adhesive masses disadvantageously sticking to each another.

The cover layer may be removable. For example, the cover layer may be a removable film or a release liner. Thus, the cover layer can be removed prior to being joined to the cartridge cover element and the microfluidic cartridge.

In a further embodiment, the cover layer is equipped with an adhesive-repellent coating on the side facing the stratified adhesive mass and/or on the side facing away from the stratified adhesive mass. The adhesive-repellent coating on the side facing the stratified adhesive mass can be particularly advantageous if the cover layer is to be removable. The adhesive-repellent coating on the side facing away from the stratified adhesive mass can be advantageous if the cartridge covering element is supposed to be rollable.

In a further embodiment, the adhesive-repellent coating is a silicone system, in particular a silicone layer coating on the cover layer. Advantageously, the adhesive-repellent coating is selected such that it exhibits a sufficient degree of dehesion in respect of the stratified adhesive mass.

In a further embodiment, the cover layer on the first side of the stratified adhesive mass and/or the cover layer on the second side of the stratified adhesive mass is a temperature- and media-resistant film, preferably a PET film, a PC film, a COP film or the like. The temperature-resistant films preferably withstand temperatures in excess of 80° C., particularly preferably of 90° C. to 125° C. The media-resistance of the films may for example be classified according to the DIBt [German Institute for Civil Engineering] check-list.

In a further embodiment, the cartridge covering element exhibits autofluorescence in a range between 230 to 450 nm. Autofluorescence in a range of 300-450 nm can be achieved with a cartridge covering element that, in addition to a stratified adhesive mass, includes at least one cover layer, such as for example a carrier film.

In a further embodiment the stratified adhesive mass of the cartridge covering element exhibits autofluorescence in a range between 300 to 450 nm. This property is particularly advantageous for invitro diagnostics, which often rely on microfluidic cartridges. The results are frequently analysed using fluorescence spectroscopy. Therefore, it is advantageous if the cartridge covering element essentially comes without any significant autofluorescence in the range of typical excitation/and detection wavelengths of commonly used fluorescent dyes. This range is from about 460 to 720 nm.

In another embodiment, the cartridge covering element is particularly suited to adhere to plastic surfaces made of COP and PET if these surfaces have previously been energetically augmented with plasma.

In another embodiment, the cartridge covering element is particularly suited to adhere to surfaces made of metal, glass, ceramics, fibre-enhanced plastic (FEP), carbon fibre plastic (CFP) and/or other high-energy surfaces.

In a further embodiment, the cartridge covering element exhibits depending on the formulation details, radiation dosage and adhesive substrates adhesion strength rates between 6 and 20 Mpa during adhesion.

In a further embodiment, the cartridge covering element is suited for (semi-)structural bonding of plastics and further low-energy surfaces.

A second aspect of the disclosure relates to a method for manufacturing a cartridge covering element according to the first aspect of the disclosure. The method comprises the following steps:
Application of the adhesive mass being tacky at room temperature on a carrier material. The adhesive mass may, for example, be applied on a carrier material using a blade. The carrier material may, for example, be a polyester film. Advantageously, the polyester film has a thickness of 10-200 μm. The carrier material may also be a temperature- and media-resistant film, alternatively a

PET film, a PC film, a COP film or the like. In a further embodiment, the adhesive mass may also contain solvents. Advantageously, the carrier material may also include an adhesive-repellent coating on one or both sides, preferably a silicone layer.
Drying of the compound. For example, the compound may first be dried at room temperature for 10 minutes and then at 80° C. in a convection oven for 10 minutes. The amount to be applied is adjusted such that a predetermined layer thickness is obtained after drying. Drying may correspond to a removal of the solvent mixture. After drying, a tacky, alternatively a tacky stratified adhesive mass can be obtained.

In one embodiment, this adhesive mass adheres already to one side of the carrier material that is intended to remain in the product. In another embodiment, the adhesive mass may first be coated onto an adhesive-repellent carrier material, for example a silicone-enhanced film and then laminated onto the cover layer intended to remain in the product after drying.

In a further embodiment, a second cover layer may be added to the compound, which advantageously serves to protect the compound.

In a further embodiment, no protective measures are required against UV light whilst handling the raw materials and the adhesive or for the coating. It is sufficient to work under regular laboratory conditions, at a distance from a UV lamp. No further shielding is required.

In a further embodiment, stamped parts can be manufactured from the compound.

A third aspect of the disclosure relates to a method for sealing off a microfluidic cartridge with a cartridge covering element according to the first aspect of the disclosure. This method comprises the following steps:
UV-activation of the cartridge covering element. The curing of the adhesive films and stamped parts is activated using UV light, preferably UVA or UVC light. For example, a UV LED lamp with a wavelength of 365 nm may be used for this purpose. Usually, the films employed in this context are sterilised with UV light prior to their application. This step can be combined with activation step so as generate additional process efficiency.
Sealing off of the microfluidic cartridge by joining a second side of the cartridge covering element and the microfluidic cartridge during the open time, respectively, prior the expiration of the open time of the stratified adhesive mass. If on that side of the adhesive mass a further cover layer is provided, for example a removable film, it should be removed prior to joining. The joining may, for example, be executed by placing the cartridge covering element on the microfluidic cartridge. Advantageously, mild pressure is exerted during this process. By providing a cover layer on the cartridge covering element on the side facing away from the cartridge, parts of the adhesive mass can be prevented from remaining stuck on the clamping means, for example a clamp plate.

The cover layer arranged on a first side of the adhesive mass can be removed after pressing. Alternatively, the cover layer may also be removed after curing. Hence, there are no or in any case fewer—requirements associated with the optical properties, such as for example autofluorescence or transparency of the cover layer.
Curing of the cartridge covering element on the microfluidic cartridge. After UV-activation, a certain period remains during which the join partners can be finally adjusted and joined. In a further embodiment, additional activation is no longer necessary after the curing has been triggered by UV light.

Due to the instantaneous adhesive force of the adhesive tape on the cartridge, the sealed cartridge can be transported further, immediately. During storage, the epoxy resin adhesive may complete its curing process fully, without any additional intervention being required. The curing reaction takes place in multiple stages. The duration of the dark reaction process may depend on different factors, such as for example the epoxy resin component used (cyclo-aliphatic or aromatic epoxy resin), the chain length, the initiator type, the irradiation time, the irradiation dosage (UV wavelength) or also the temperature.

The curing time after irradiation can amount to between 0 seconds and 60 minutes, depending on the aforementioned factors and their interaction.

In a further embodiment, the stratified adhesive mass has essentially completed its reaction after a maximum of two hours so that the adhesive in the ducts is no longer tacky. Thermosets are known for their high resistance against temperatures and chemicals. For essays reacting sensitively to monomers, subsequent storage (for example 1 hour at ca. 60° C.) may help finalise the reaction of the last monomers.

In a further embodiment, the stratified adhesive mass cures without the application of heat.

In yet another embodiment, the stratified mass cures subject to application of heat.

The stratified adhesive mass may exhibit very high seal strength, comparable to the seal strength of hot seal films, however, it hardens at room temperature and can thus also be used for heat-sensitive reagents. Advantageously, the method requires no hot sealing station. Alternatively, such a hot sealing station may be utilised, because the wetting of the stratified adhesive mass on the surface of the microfluidic cartridge can be increased by slightly raising the temperature, for example to 35° C.-45° C.

In a further embodiment, the stratified adhesive mass cures without the additional application of UV light.

In a further embodiment, the UV-activation takes place during spatial separation from the microfluidic cartridge, alternatively, the UV-activation takes place on the microfluidic cartridge, this means during or after the joining of the cartridge covering element and the cartridge.

In another embodiment, the UV-activation takes place prior to the joining of the cartridge covering element and the microfluidic cartridge, alternatively, the UV-activation takes place during or after the joining of the cartridge covering element and the cartridge.

Given that the adhesive mass can remain tacky for a certain time also after UV-activation during the open time, the UV-activation may also already take place prior to joining the cartridge covering element and the microfluidic cartridge. This also allows for UV-activation of the stratified adhesive mass during spatial separation from the microfluidic cartridge, for example outside of the sealing station with the microfluidic cartridge as provided. This allows for the UV-irradiation not to affect the functionality of the microfluidic cartridge or the functionality of the reagents used. In a further embodiment, the UV-activation during spatial separation results in sterilisation of the cartridge covering element.

In turn, UV-activation of the stratified adhesive mass after joining can be advantageous to improve process efficiency. For example, the UV-activation serves to sterilise the microfluidic cartridge, too, which may save a separate sterilisation step.

Described hereinafter are embodiments based on the Figures. In this, identical or similar elements or elements with the same effect are referenced with identical reference numerals in the different Figures, and these elements are not repeatedly described so as to avoid redundancies.

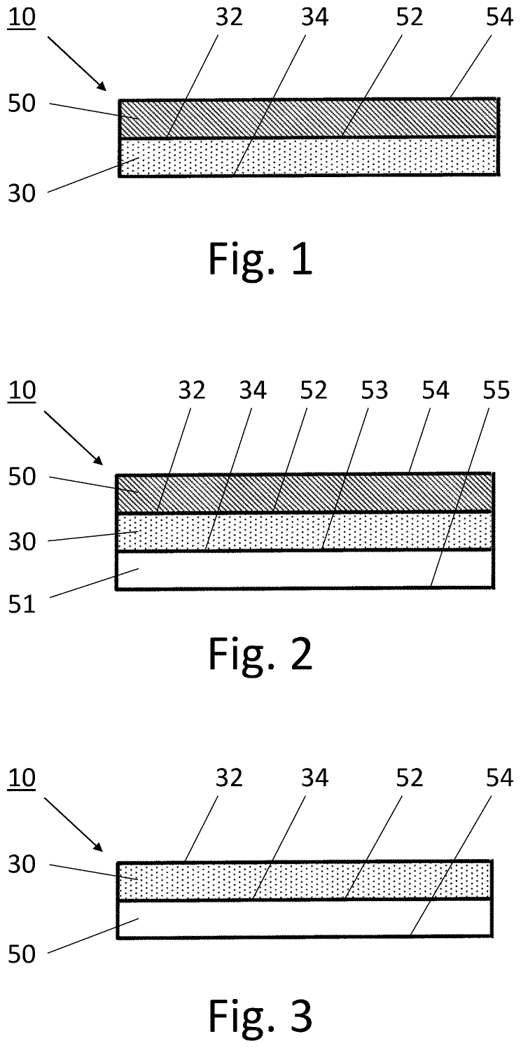

FIG. 1 schematically shows an embodiment of the cartridge covering element 10, comprising a stratified adhesive mass 30. The composition of the stratified adhesive mass 30 is determined by the ranges specified below:
i. 2-40 percent by weight of film formers,
ii. 10-70 percent by weight of aromatic epoxy resins,
iii. cyclo-aliphatic epoxy resins, the cyclo-aliphatic epoxy resins not exceeding 35 percent by weight,
iv. 0.5-7 percent by weight of cationic initiators,
v. 0-50 percent by weight of epoxy-enhanced polyether compounds, and
vi. 0-20 percent by weight of polyol, the shares adding up to 100%.

In the present embodiment, the stratified adhesive mass 30 comprises:
i. 11 percent by weight of film formers,
ii. 58 percent by weight of aromatic epoxy resins,
iii. 10-70 percent by weight of aromatic epoxy resins,
iv. 2 percent by weight of cationic initiators,
v. 12 percent by weight of epoxy-enhanced polyether compounds, and
vi. 7 percent by weight of polyol,

Below follows a list of specific product names of the individual components of the stratified adhesive mass 30:
i. 11 percent by weight of film formers, in particular Desmomelt 530,
ii. 58 percent by weight of aromatic epoxy resins, in particular 38 percent Araldite GT 7072 and 20 percent D.E.R. 331.
iii. 10 percent by weight of cycloaliphatic epoxy resins, in particular Uvacure 1534,
iv. 2 percent by weight of cationic initiators, in particular Chivacure 1176,
v. 12 percent by weight of epoxy-enhanced polyether compounds, in particular D.E.R. 736 P, and
vi. 7 percent by weight of polyol, in particular PEG 400.

In the cartridge covering element shown in FIG. 1, the thickness of the stratified adhesive mass amounts 30-70 μm. Alternatively, the thickness can amount from 2 to 1000 μm, preferably from 5 to 500 μm and particularly preferably from 5 to 100 μm. The first side of the stratified adhesive mass 32 and the second side of the stratified adhesive mass 34 are shown schematically, as well.

On the first side 32 of the stratified adhesive mass 30, a cover layer 50 is arranged in the form of a polyester film carrier. Any other cover layer can also be used as the cover layer, preferably a plastic film. Advantageously, the cover layer 50 may also be a temperature- and media-resistant film, preferably a PET film, a PC film, a COP film or the like.

The cover layer 50 in this embodiment has a thickness of 100 μm, but it also may have a different thickness, in particular a thickness of 10-200 μm. The cover layer 50 in this embodiment has an adhesive-repellent coating on the side 54 facing away from the stratified adhesive mass 30. Alternatively, however, any other adhesive-repellent coating could be provided, in particular a silicone system.

Advantageously, the adhesive-repellent coating is selected such that it exhibits a sufficient degree of dehesion with respect to the epoxy resin system. This is advantageous in that the cartridge covering element 10 may, for example, be rolled up for storage purposes.

The cover layer 50 is preferably selected such that its autofluorescence is not in the wavelength range that is used in customary fluorescence dyes. That is not the case in this embodiment, as the autofluorescence of the adhesive mass and the cover layer is in the range of 230-450 nm.

The polyester film carrier 50 in this embodiment has no further coating on the side 52 facing the stratified adhesive mass 30. In this embodiment, this is advantageous because the cover layer 50 is intended to remain on the stratified adhesive mass 30. The cover layer 50 may thus for example serve as a one-sided protective film for the stratified adhesive mass 30 of the cartridge covering element 10.

The stratified adhesive mass 30 is UV-activatable to induce curing and being tacky at room temperature prior to and after activation until expiration of an open time.

FIG. 2 schematically shows a cartridge covering element 10, which essentially corresponds to the cartridge covering element 10 of FIG. 1. The cartridge covering element 10 shown in FIG. 2 is different from the cartridge covering element shown in FIG. 1 in respect of the features outlined below.

In this embodiment, on the second side 34 of the stratified adhesive mass 30 an additional cover layer 51 in the form of a PET film is arranged. Alternatively, any other cover layer may be arranged, preferably in the form of a removable film. The cover layer 51 in this embodiment has a thickness of 50 μm, but it also may have a different thickness, in particular a thickness of 2 to 1000 μm, preferably of 5 to 500 μm and particularly preferably of 5 to 100 μm.

The cover layer 51 has a silicone coating on the side 53 facing the stratified adhesive mass 30, but it could also include any other adhesive-repellent surface. Advantageously, the adhesive-repellent coating is selected such that it exhibits a sufficient degree of dehesion with respect to the epoxy resin system. This may be necessary for the ability to remove the PET film prior to the joining step to the microfluidic cartridge. Thus, the cover layer 51 operates as a removable film.

Moreover, the cover layer 51 has a silicone coating on the side 55 facing away from the stratified adhesive mass 30. Alternatively, the cover layer may have any other adhesive-repellent surface. The silicone coating on the side 55 facing away from the stratified adhesive mass 30 serves storage purposes and, for example, facilitates rolling and unrolling of the cartridge covering element 10 in the event that the latter is supposed to be stored rolled up.

FIG. 3 schematically shows a cartridge covering element 10 comprising a stratified adhesive mass 30 that corresponds to the adhesive mass of FIG. 1.

The cartridge covering element according to FIG. 3 just has a cover layer 51 in the form of a PET film arranged on the second side 34 of the stratified adhesive mass 30. The configuration and properties of the cover layer 51 shown in FIG. 3 correspond to the configuration and properties of the second cover layer of FIG. 2. As the cover layer 51 does not remain in the product, there are no requirements associated with its autofluorescence properties.

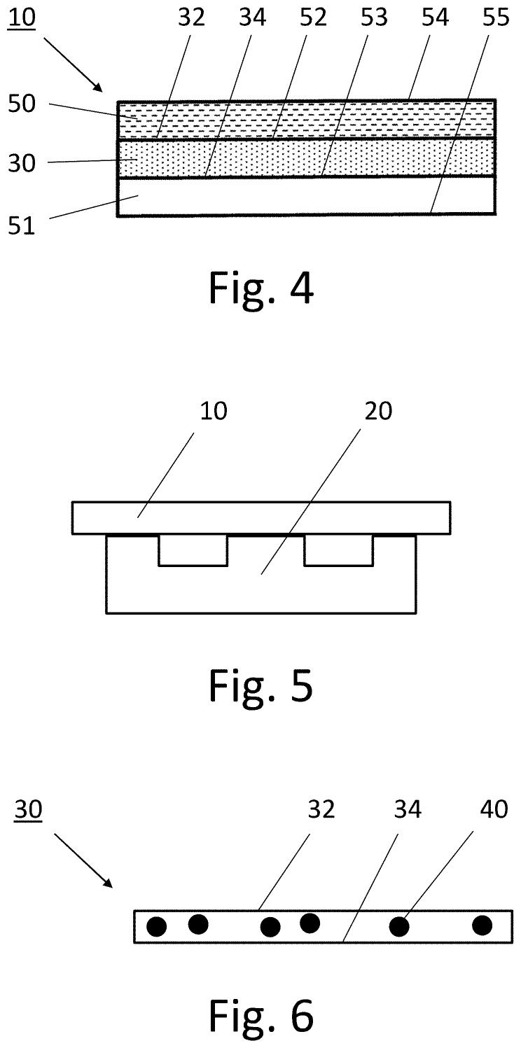

FIG. 4 schematically shows an embodiment of the cartridge covering element 10, which essentially corresponds to the cartridge covering element of FIG. 1.

The cartridge covering element 4 shown in FIG. 4 is different from the cartridge covering element according to FIG. 1 in that the covering layer 50 in the form of a PET film has a silicone coating on the side 52 facing the stratified adhesive mass 30. Alternatively, the cover layer 50 may include any other adhesive-repellent surface.

Advantageously, the adhesive-repellent surface is selected such that it exhibits a sufficient degree of dehesion, i.e. that it can be removed manually or automatically without major exertion of force and without causing external damage or negative functional impairment of the adhesive surface of the epoxy resin system. This may be employed for the ability to remove the cover layer 50 prior to being joined to the microfluidic cartridge. The cover layer 50 includes a silicone coating on the side 54 facing away from the stratified adhesive mass 30, as well. Also this coating may alternatively be any other adhesive-repellent surface.

Thus, the cartridge covering element 10 according to FIG. 4 has a removable cover layer 50, 51 on both sides of the adhesive mass 30. A double-sided removable film may be advantageous particularly in respect of the significant quality requirements regarding the optical appearance of the product.

FIG. 5 schematically shows a cartridge covering element 10 joined to a microfluidic cartridge 20. The cartridge 20 has recesses on one upper surface such as for example cavities, chambers, ducts etc., serving to receive reagents such as, for example, in-vitro assays in order to perform in-vitro diagnostics. In this context, the cartridge covering element 10 is arranged such on the cartridge 20 that the recesses in the surface of the cartridge 20 are sealed off with respect to their surroundings.

FIG. 6 schematically shows a stratified adhesive mass 30 comprising fillers 40 in the form of solid glass spheres. The maximum dimensions of the fillers 40 are smaller than the thickness of the stratified adhesive mass 30. The fillers 40 may, inter alia, have a positive impact on the elastic properties of the stratified adhesive mass and the elastic properties of the cartridge covering element, which in turn may result in an advantageous sealing of the microfluidic cartridge.

Alternatively, the stratified adhesive mass 30 may also comprise other fillers 40 such as, for example, hollow glass spheres and/or polymer spheres. However, also fillers 40 can be used comprising in different materials, for example, ceramic fillers or polymer-based fillers. The first side of the stratified adhesive mass 32 and the second side of the stratified adhesive mass 34 are shown schematically, as well.

Insofar as applicable, all individual features illustrated in the sample embodiments can be combined and/or exchanged without leaving the scope of the disclosure.

The desired material properties for the use in in-vitro diagnostics (silicone layer, carrier, adhesive system) are listed below.

For replicating the pathogen-DNA cyclical heating and cooling is required. To this end, the reagents are heated to ca. 95° C. for 30 seconds and subsequently cooled down to ca. 60° C. in approx. 50-100 cycles. The film material and the seal is be capable of withstanding these temperature cycles. Advantageously, the seal is heat-resistant 50-100 times for 20 seconds at ≥90° C.

The results are detected using fluorescence spectroscopy. For detection an optically transparent seal (transmission >90%) is advantageous. The following wavelengths are used for detection and should be able to pass the material without being altered.
green: excitation: 470±10 nm; detection: 510±05 nm
yellow: excitation: 530±05 nm; detection: 557±05 nm
orange: excitation: 585±05 nm; detection: 610±05 nm
red: excitation: 625±05 nm; detection: 660±10 nm
crimson: excitation: 680±05 nm; detection: 712±05 nm

As the detection of the results is performed using fluorescence spectroscopy, the material should also not exhibit fluorescence within the range of the detection wavelengths.

The seal weld strength should be able to withstand a pressure of 1 bar at 100° C. (corresponds to 0.1 N/mm²).

The sealing layer in contact with the product should not contain any ingredients that would influence the biochemistry of the sample material or the reagents.

Different alcoholic solvents are used during the process. Therefore, chemical stability with respect to solvents such as ethanol or isopropanol (diluted solutions; 50%) is advantageous.

The material can be adapted not to exhibit embrittlement and can remain flexible (yet not pliable) after production. It should also not break after use during waste removal to prevent substance leakage, such as for example reagents or blood contaminated with pathogens.

During processing of the film, leakage of toxic substances can be prevented that might negatively affect the operating or handling staff's health.

The material can exhibit low water absorbency (<10% during the 2-hour processing time). The less water absorbency, the lower the risk for pathogens to accumulate on or to attach to the material or for material properties to be modified.

To ensure appropriate processing runtime, sufficient adherence of the sealing film to the microfluidic cartridge 20 should be provided after 20 seconds so that it can be packaged subsequently. Completion of the curing process may be achieved during storage.

Another optical requirement in respect of the adhesive is that no bubbles should form during the curing of the adhesive constitutes

The microfluidic cartridges are covered in a clean room at generally low humidity conditions of ca. 35-50 rH.

### LIST OF REFERENCE NUMERALS

10 cartridge covering element

20 microfluidic cartridge

30 stratified adhesive mass

32 first side of the stratified adhesive mass

34 second side of the stratified adhesive mass

40 filler

50 cover layer

51 cover layer

52 side of the cover layer facing the stratified adhesive mass

52 side of the cover layer facing the stratified adhesive mass

54 side of the cover layer facing away from the stratified adhesive mass

55 side of the cover layer facing away from the stratified adhesive mass

1. A cartridge covering element for
sealing off a microfluidic cartridge comprising:
at least one stratified adhesive mass
adapted to be UV-activatable to induce curing and
adapted to be tacky after activation until expiration of an open time at room temperature.

2. The cartridge covering element of claim 1, wherein components of the stratified adhesive mass comprises:
i. 2-40 percent by weight of film former,
ii. 10-70 percent by weight of aromatic epoxy resins,
iii. cyclo-aliphatic epoxy resins, the cyclo-aliphatic epoxy resins not exceeding 35 percent by weight,
iv. 0.5-7 percent by weight of cationic initiators,
v. 0-50 percent by weight of epoxy-enhanced polyether compounds, and
vi. 0-20 percent by weight of polyol,
such that shares of the components by weight up to 100%.

3. The cartridge covering element of claim 1, the stratified adhesive mass having a thickness of 2 to 1,000 μm.

4. The cartridge covering element of claim 1, wherein the stratified adhesive mass comprises fillers.

5. The cartridge covering element of claim 4, wherein the fillers include solid glass spheres, hollow glass spheres, or polymer spheres, or any combination thereof.

6. The cartridge covering element of claim 4, wherein the maximum dimensions of a filler are smaller than the thickness of the stratified adhesive mass.

7. The cartridge covering element of claim 1, the stratified adhesive mass comprises a cover layer arranged on a first side of the stratified adhesive mass or a second side of the stratified adhesive mass, or on both sides of the stratified adhesive mass.

8. The cartridge covering element of claim 7, wherein the stratified adhesive mass comprises the cover layer on both sides of the stratified adhesive mass.

9. The cartridge covering element of claim 7, wherein the cover layer has an adhesive-repellent coating on a side facing the stratified adhesive mass or on a side facing away from the stratified adhesive mass, or on both sides of the cover layer.

10. The cartridge covering element of claim 7, wherein the cover layer is a temperature- and media-resistant film.

11. The cartridge covering element of claim 1, wherein the cartridge covering element exhibits autofluorescence in the range of 230 to 450 nm.

12. A method for manufacturing a cartridge covering element of claim 1, comprising:
a) the stratified adhesive mass at room temperature on a carrier material when the stratified adhesive mass is tacky; and
b) drying the stratified adhesive mass.

13. A method for sealing off a microfluidic cartridge with the cartridge covering element of claim 1 comprising:
UV-activation of the cartridge covering element; sealing off the microfluidic cartridge by joining a second side of the cartridge covering element and the microfluidic cartridge within an open time of the stratified adhesive mass; and
curing the cartridge covering element on the microfluidic cartridge (20).

14. The method of claim 13, wherein the UV-activation of the cartridge covering element takes place with the cartridge cover element spatially separated from the microfluidic cartridge.

15. The method of claim 13, wherein the UV-activation activation of the cartridge covering element takes place prior or during the joining of the cartridge covering element and the microfluidic cartridge.

16. The cartridge covering element of claim 3, wherein the stratified adhesive mass has a thickness of 5 to 500 μm.

17. The cartridge covering element of claim 16, wherein the stratified adhesive mass has a thickness of 5 to 100 μm.

18. The cartridge covering element of claim 4, wherein the stratified adhesive mass comprises ceramic fillers or polymer-based fillers, or both.

19. The cartridge covering element of claim 10, wherein the cover layer comprises a plastic film.

20. The cartridge covering element of claim 20, wherein the cover layer a polyethylene terephthalate film, a polycarbonate film, or a cyclic olefin copolymer film, or any combination thereof.

21. The cartridge covering element of claim 8, wherein the cover layer on the second side of the stratified adhesive is a removable film.
